(19) United States
(12) Patent Application Publication
(10) Pub. No.: US 2014/0188564 A1
(43) Pub. Date: Jul. 3, 2014

(54) SYSTEMS AND METHODS FOR SEGMENTING BUSINESS CUSTOMERS

(71) Applicant: PITNEY BOWES INC., Stamford, CT (US)

(72) Inventors: Venkat Ram Ghatti, Stamford, CT (US); John A. Merola, Hudson, NY (US)

(73) Assignee: PITNEY BOWES INC., Stamford, CT (US)

(21) Appl. No.: 13/731,333

(22) Filed: Dec. 31, 2012

(51) Int. Cl. G06Q 30/02

(52) U.S. Cl. CPC G06Q 30/0204
USPC 705/7.33

(57) ABSTRACT

Systems and methods for providing market segmentation using a unique two-stage clustering system are provided. The system may also employ regional interpolation and estimation methods that account for local business environment. In certain additional configurations, a generic geo-firmographic model is enhanced with seller data such as data specific to a particular vertical market and/or data specific to a particular seller's business customers.

### TECHNICAL FIELD

The illustrative embodiments of the present invention relate generally to marketing segmentation systems and, more particularly, to new and useful systems and methods for business to business (B2B) market segmentation of business customers using a unique two-stage clustering system that may also employ regional interpolation and estimation methods.

### BACKGROUND

Targeted marketing is generally considered an important part of a business marketing effort and entails trying to focus advertising on those who are more likely to purchase a product. If fact, targeted marketing services in the business to consumer (B2C) space is a significant business and those services permits various retail organizations to effectively target consumers who are potential customers while reducing the retail marketing budget. However, there are also approximately 27 million small businesses in the United States according to the U.S. Small Business Administration. A typically Small to Medium Business (SMB) is a business with less than $7 million in revenues and/or fewer than 500 employees.

A popular business to consumer (B2C) targeting marketing tool is the PSYTE HD geodemographic segmentation tool available from Pitney Bowes Software, Inc. of Troy, N.Y., that uses “psychographic” indicators for consumers to provide a relatively accurate “snapshot” of American neighborhoods. Additionally, B2B marketing segmentation tools exist such as the D&B Business Segmentation product available from D&B of Short Hills, N.J. The D&B SEGMENTER provide business segmentation using existing D&B data points such as the size of the business, the applicable Standard Industrial Classification (SIC) code and a risk score that D&B assigns to the business. Other targeted marketing segmentation products and or related data are available from Infogroup of Papillion, Nebr. and Experian of Costa Mesa, Calif. Some systems allow segmentation by demographic-like data points including a number of employees and/or a number of locations. Additionally, some systems use the six-digit North American Industry Classification System (NAICS) code instead of SIC codes.

However, the prior B2B systems focus on demographic-like data. Additionally, attempting to apply a consumer-like psychographic model is not straightforward for several reasons. For example, the impact of locational attributes on the SMB may be different than for consumers. Also, additional individual-business level data may be available that would not be available for consumers in a similar system.

Accordingly, there is a need, among other needs, for systems and methods that provide more useful marketing segmentation and also for a unique two-stage clustering system that may be used segmentation of business customers.

### SUMMARY

Illustrative system and methods for providing market segmentation using a unique two-stage clustering system are provided. The system may be used for market segmentation of business customers and may also employ regional interpolation and estimation methods that account for local business environment.

In certain additional embodiments, a generic geo-firmographic model is enhanced with seller data such as data specific to a particular vertical market and/or data specific to a particular seller's business customers.

### BRIEF DESCRIPTION OF THE DRAWINGS

The accompanying drawings show illustrative embodiments of the invention and, together with the general description given above and the detailed description given below serve to explain certain principles of the invention. As shown throughout the drawings, like reference numerals designate like or corresponding parts.

FIG. 1 is a diagram showing a system and information flow for providing market segmentation of business customers using a unique two-stage clustering system according to an illustrative embodiment of the present application.

FIGS. 2A, 2B and 2C is a process flow diagram showing a unique two-stage market segmentation clustering system according to an illustrative embodiment of the present application.

### DETAILED DESCRIPTION

The illustrative embodiments of the present invention described herein are often described in the context of a marketing B2B segmentation tool operating on data from one or more databases. In certain embodiments, systems and methods for market segmentation using a unique two-stage clustering system are provided. The system may be used for market segmentation of business customers and may also employ regional interpolation and estimation methods that account for local business environment. In certain additional embodiments, a generic geo-firmographic model is enhanced with seller data such as data specific to a particular vertical market and/or data specific to a particular seller's business customers.

Several novel segmentation and clustering approaches are described. For example, several of the illustrative embodiments described herein use a unique centering and scaling method before performing a principal components analysis. Certain illustrative embodiments employ interpolation and estimation techniques such as gridding in which data points are creates as required for members of a market area.

There are several statistical methods described herein that are described with reference to the programming language and libraries known as the R programming language available from The R Foundation for Statistical Computing of Vienna, Austria. Additional statistical systems may be used as appropriate such as the IBM SPSS system, available from IBM Corp. of Armonk, N.Y. In certain illustrative embodiments, the systems and methods described provide more accurate targeting of small and medium business market opportunities such as by providing a list having a relatively small number of target companies compared to the available universe of possible companies, wherein the listed companies are more likely to make the targeted purchase.

Traditional B2B segmentation solutions available in the market focus on industrial classification (SIC, NAICS) and demographic-like data such as number of employees and sales volume. However, these variables do not provide a rich perspective on the business landscape and do not provide information necessary to craft the marketing message or to choose the appropriate marketing message delivery channel. Additionally, there are availability and accuracy problems when relying on data reported for individual businesses, especially for SMBs (small and medium businesses). The data reported for individual businesses is often unavailable or inaccurate and is less frequently updated. Accordingly, the systems using such data must deal with large amounts of missing data. Moreover, the ever changing SMB landscape and the inherent dynamic nature of SMBs in terms of their transition thru their various business life stages makes it even harder to build and maintain a segmentation system based on the data for individual businesses.

Several illustrative systems and methods described herein provide a rigorous classification of market areas and based on leading indicator economic & geo-firmographic data. Unlike existing segmentation and clustering models which focus on traditional firmographic attributes such as historic sales, number of employees and classification codes, the systems herein classify SMB “markets/neighborhoods” using a comprehensive list of firmographic attributes and profiling of the resultant clusters using economic and business psychographic/attitudinal variables. The system utilizes economic and geo-firmographic aspects of a location to profile and provide a vital predictive analytic tool for a wide range of business applications.

In additional configurations, the segmentation variables are combined with other key variables from customer data to create a new and unique customer segmentation. In certain configurations, the system will smooth out roughness in the results by aggregating irregular data into relevant “markets/neighborhoods.” The system takes into consideration that the SMB business environment is highly dynamic and appropriate “markets/neighborhoods” will identify where these dynamics are unique. Moreover, certain data is selected that provides a leading indicator of the market rather than a lagging indicator such as is common when using business historical data.

In many configurations described herein, the system does not just work with individual data points for a business, but rather initially builds an appropriate “neighborhood” or “market area” using interpolation and estimation methodologies such as “Gridding” and “Kernel Smoothing” where data points are created as required members for the market area that includes that business. Aggregating by the proximity measures between the neighborhoods, the system creates groups of multiple market areas using clustering techniques.

The illustrative embodiments herein are described with regard to targeted marketing variables and potential customers in a B2B marketing scheme. In examples herein, at least 5 directly related variables may be used, whereby Directly Related (DR) means related to the potential customer business such as a potential target SMB including for example, number of employees or annual revenue. Similarly, at least 3 indirectly related variables may be used, whereby Indirectly Related (IR) means variables indirectly related (at least as used) to the potential customer business such as a potential target SMB including for example, number of large employers in the area. In an alternative below, IR variables may include directly related variables obtained from a client dataset, described in more detail below. Moreover, many different variable combinations are possible including: DR 10, IR 4; DR 20, IR 5; DR 50, IR 10, DR 100, IR 10, DR 100, IR 20, DR 200, IR 25; DR 150, IR 200; and the like with many different variables used.

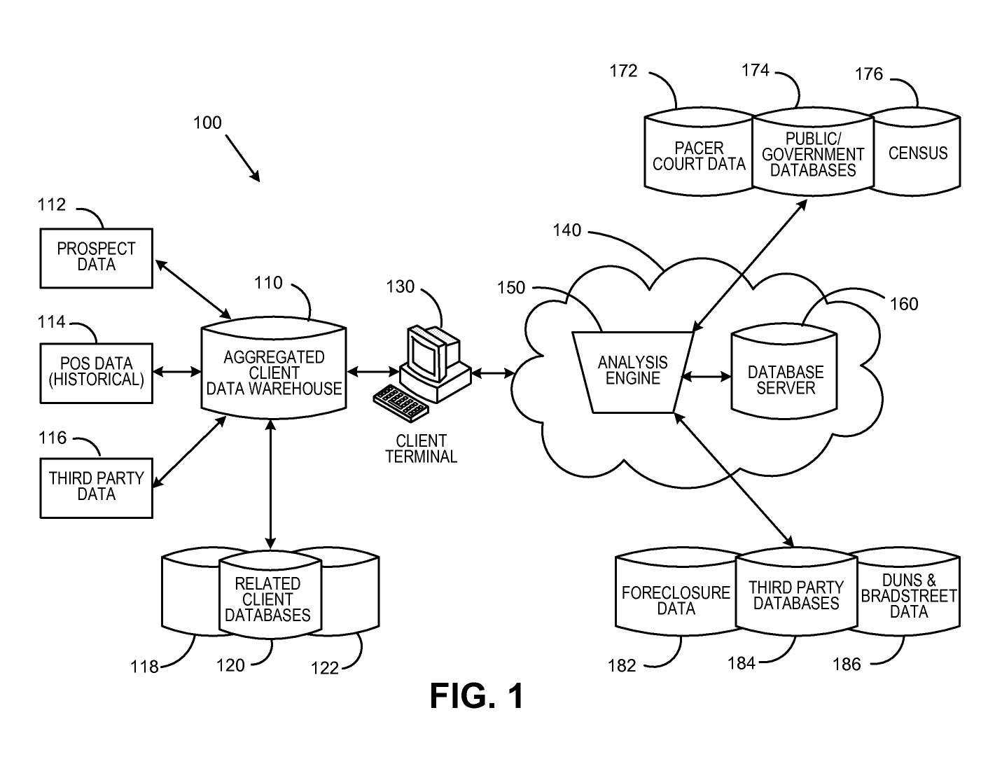

Referring to FIG. 1, a diagram showing a system 100 and information flow for providing market segmentation of business customers using a unique two-stage clustering system according to an illustrative embodiment of the present application is provided. The illustrative processes described herein may be performed on generic data to obtain one or more generic market segmentations. Similarly, generic vertical market data may be utilized to achieve vertical market segmentations that are not specific to any seller in that vertical. However, the process may also take seller specific data as an input to customize the output market segmentation for a particular seller.

A typical Client is represented by Client terminal 130. This client may access a generic market segmentation or may engage the system for a customized segmentation. If the system 100 is configured in a Software as a Service (SaaS) model, the client terminal 130 may be a personal computer using a web browser to access the system 140 in a cloud through an internet connection. In an on premise solution, the system 140 and associated systems may be located on a server behind the client firewall. In such a case, client terminal may utilize a heavy client or alternatively a web browser to access that server using a local area network (LAN). In another model, the client terminal 130 may run a customized application that interfaces with the custom segmentation system using an Application Program Interface (API).

In this case, the client terminal 130 has access such as across a LAN to an aggregated client data warehouse 110 that stores several different types of data that is relevant to the segmentation process. The aggregated client data warehouse 110 has access such as across a LAN to several databases including prospect data 112, Point of Sale (POS) historical data 114, third party data 116 and related client databases 118, 120, 122. In this illustrative example, the prospect data may include a previously purchased list of potential business customers. The data may be cleansed by first removing current customers. After that, the segmentation system described herein may be used to target a subset of the remaining prospects for marketing action. The POS data 114 may be used to further customize the segmentation profiles based upon actual buying history of business customers of client 130 using the segmentation techniques described.

Third party data 116 may include some of the same data that the generic segmentations are based on and may also include more thorough data bought from a different third party. The analysis engine may utilize such data as additional and/or replacement data. The related client databases 118, 120, 122 typically include data for specific vertical markets or submarkets such as insurance, banking, and private banking, respectively.

The segmentation processing system is shown in cloud 140 in this illustrative embodiment. The analysis engine 150 executes the code to run the processes described herein and may run as a cloud process in a virtual machine or may instead run on a dedicated server such as a DELL XEON based server running WINDOWS ENTERPRISE 7. The database server 160 may be a cloud data instance, may be a standalone database or may be included on the same server that hosts the analysis engine. In an illustrative example, the database server 160 is SQL SERVER 2012. Several external databases may be accesses in real time or prior to execution of the processes running on the analysis engine 150. For example, the external data sources may be accessed using one or more of SOAP/REST web services, custom APIs or even data transfer in XML or other data format using file transfer protocol FTP, email, HTML or even physical media transfer into a file or database on the database server 160.

Here, database 172 includes PACER court data such as bankruptcy filings data. Database 174 represents one or more other public/government databases such as those that provide economic indicators by geography such as employment numbers and unemployment numbers. Here, database 176 is specifically provided for United States government census data. Database 182 includes foreclosure data such as that available from commercial firm REALTYTRAC of Irvine, Calif. Similarly, database 186 includes a variety of data that is available from D&B. Additional third party databases are represented by database 184.

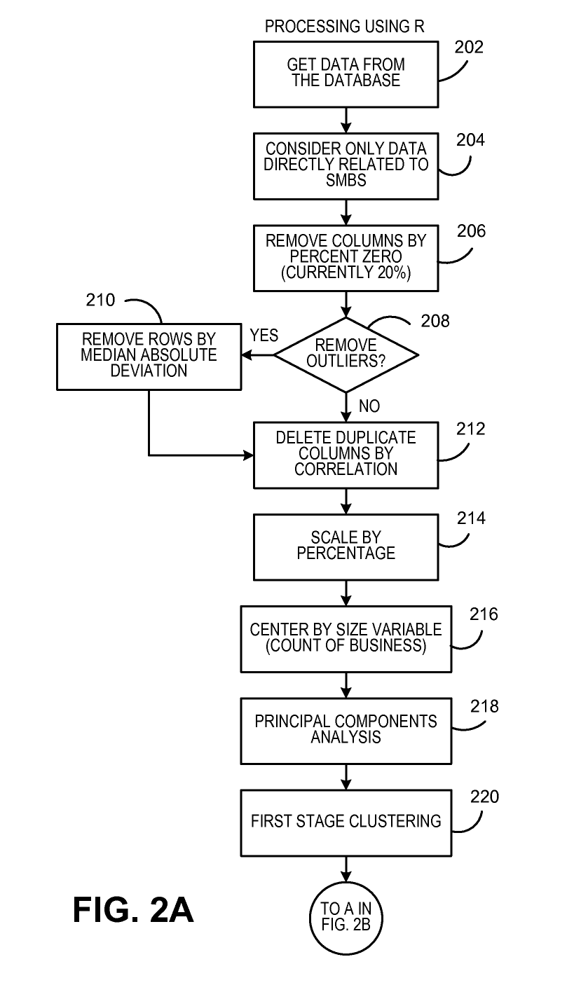

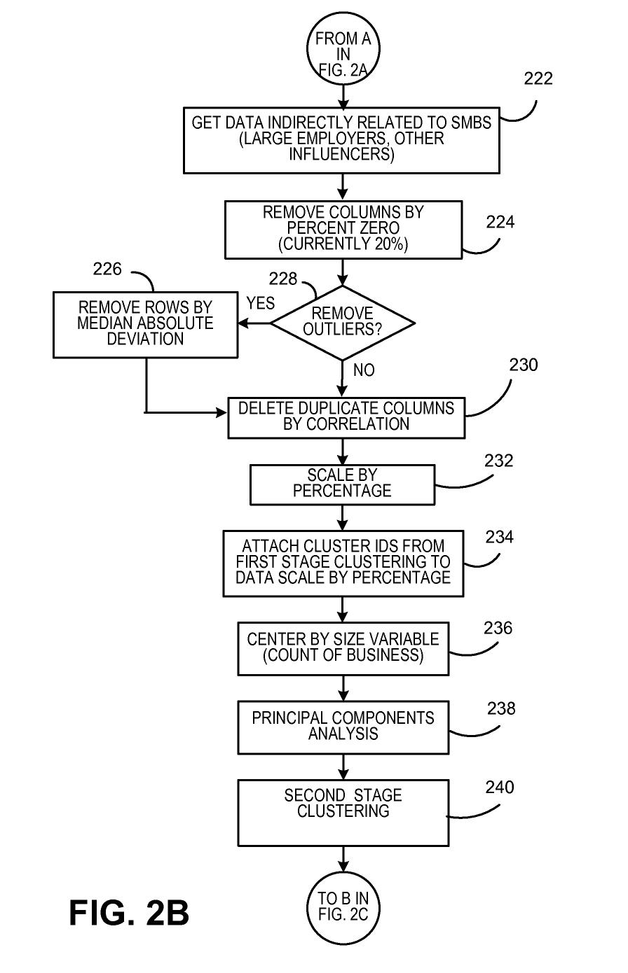

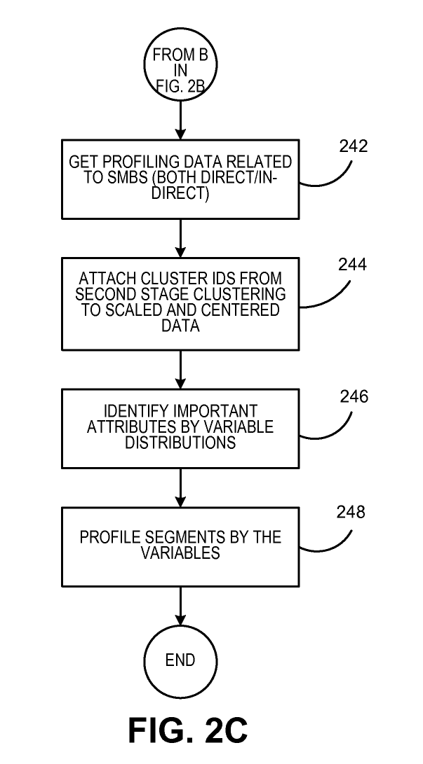

Referring to FIGS. 2A, 2B, 2C, a process flow diagram showing a unique two-stage market segmentation clustering system according to an illustrative embodiment of the present application is provided. Clustering may be considered a form of unsupervised classification. In the illustrative process shown below, certain data may be described that is optionally used, although as described at least one of a certain class or group of variables must be present and in other cases, no variable of certain other groups or classes may be present in certain stages of processing. As can be appreciated, a global dataset of direct and indirect data for a large set of business such as SMBs across the United States can be segmented differently by only considering a subset of each of the direct and/or indirect variable. As discussed above, an illustrative program for executing the processes described is written in the R programming language and considers SMBs.

In step 202, the system obtains data from the database such as 160. The database 160 may have already been populated with the relevant external data described above 172, 174, 176, 182, 184, 186. In one illustrative configuration, a set of about 350 variables from the datasets 184 and 186 mentioned are utilized as described herein. One of skill in the art with the datasets can use a typical configuration, or even all available variables.

In step 204, the system considers only data Directly Related to the SMBs (even if in the aggregate) such as certain data in 184 and 186 in a first stage of this clustering algorithm. In step 206, the system removes columns of data that have too many voids or are too sparse. Unlike consumer data, business related data is often found with many fields missing. In such cases, if a selected variable (equivalent to a “column”) has missing data 20% or more records or SMBs, that entire column or variable is removed from the dataset under consideration. The threshold value 20% has been found empirically and can be modified with varying degrees of effectiveness from not performing the step through removing the column is over 5% is missing, 10% is missing, 15% is missing or 25% is missing.

In step 208, the system removes outlier such as records that are so far from the norm or an average or a mean that they would likely skew the results too much. For example, sales number for stores on Madison Avenue in New York City might be removed for clustering of countrywide data, but not be removed if clustering was performed for Manhattan in New York. If outliers are to be removed, the illustrative sub process used in step 210 is to remove rows (SMB records) by using the median absolute deviation function. Alternatively, any robust statistics model may be used.

Next in step 212, a custom sub process removes so-called “duplicate” columns (variables) by correlation. In multivariate statistics, highly correlated variables hides or masks good results. Accordingly, the goal of this portion of the process is to only use variables that are not highly correlated. In order to accomplish that goal, a sub process having the pseudo-code for step 212 to provide a set of variables that are not too highly correlated with one another is used as shown below:

Set correlation threshold, such as at R=0.90;

[Depending on number of variables R can be adjusted in the range such as R=0.65-0.90, empirically determined, such as 0.65, 0.70, 0.75, 0.80, or 0.85, etc.]

Iteratively process the variables use Pearson correlation;

Output set of variables with less than 0.90 correlation.

As can be appreciated, the R variable may result in several columns (variables) being removed from a dataset because many publically available datasets have variables that are similar in some way. For example, for a particular zip code, the daytime population number and the employment statistics variable may be 90% correlated. In that case, the system selects one to use and discards the other. The selection of a variable to keep may be random or based on one or more factors. For example, a certain dataset may be given preference in a hierarchy, known to be more indicative or valuable in differentiating SMBs.

In step 214, the remaining dataset is scaled by percentage using a known process. In step 216, a standard centering algorithm is used. In this illustrative example though, the centering is done by the size variable (count of business).

Next in step 218, the dataset is processed through a principal components analysis. In this illustrative example, the standard prcomp routine in the R language is used, but with scaling and centering turned off by parameter. The default prcomp routine would apply a default scaling and centering if those features had not been intentionally turn off. In this way, the novel scaling and centering method described herein may be used without interference.

In yet another alternative, a substitute principal components analysis process may be used according to those taught in commonly-owned, co-pending U.S. Patent Application No. 61/747,462, filed by Cordery, et al., entitled Systems and Methods for Enhanced Principal Components Analysis, on Dec. 31, 2012, such application being incorporated by reference herein in its entirety. In yet other alternatives, prcomp scaling and/or centering may be substituted.

In step 220, the first stage clustering is performed on the dataset. In an illustrative embodiment, the Two-Step clustering function in the commercially available SPSS package from IBM Corp. of Armonk, N.Y. is utilized. Alternatively, the K-means function of the R programming language may be used.

In step 220, the system attaches cluster Identifiers from the first stage clustering, e.g., the scaled and centered data from step 214. These cluster identifiers will also be assigned to the second stage data in step 220. All data used in the second stage is aggregated to the first stage cluster identifier before analysis continues. The aggregation can be done in the database 160, or alternatively using the R programming language.

The second stage involving the Indirectly Related data is now described. For many variables, the data is taken from the same sources as the earlier described Directly Related variables. For example, the number of large employers in an area could then be used as an outside influence on nearby SMBs, perhaps with more effect in certain SIC code areas. Another example to assist with a qualitative understanding of the processing is that a zip code having a University or a Medical Center might be good for coffee shops, etc. Similarly, a zip code with a large shopping center or nearby big box store may be good or bad for certain SMBs. Accordingly, in step 222, the system obtains variables and associated data that is Indirectly Related to the SMBs.

In this illustrative example, the Indirectly Related dataset is processed separately until step 234 below in a “B” dataset compared to the “A” dataset introduced in step 204.

In an alternative, the Customer Data from 110 described above may be introduced here in step 222. In this case, the customer data is considered Indirectly Related data even though the specific data may indeed relate to particular SMBs. Alternatively, the data is obtained on the fly as needed or otherwise. In one example, a clustering effort directed at potential customers for postage meters might be used.

In step 224, the system again removes columns that have 20% or more missing data as described above with reference to step 206. Here, the value may be the same or independently derived compared to the value in step 206. Similarly, a range of values may be appropriate and may differ from those in step 206, but may also include 5%, 10%, 15% and 25%.

In step 228, the system may again remove outliers in a similar fashion as described with reference to step 208. If the system is configured to or directed to, potential customers such as SMB records or rows are removed by the median absolute deviation function in step 226. Similarly as described above with reference to step 210, any robust statistics model may be used alternatively.

Next in step 230, similarly to step 212, a custom sub process removes so-called “duplicate” columns (variables) by correlation. In multivariate statistics, highly correlated variables hides or masks good results. Accordingly, the goal of this portion of the process is to only use variables that are not highly correlated. In order to accomplish that goal, a sub process having the pseudo-code for step 230 to provide a set of variables that are not too highly correlated with one another is used as shown below:

Set correlation threshold, such as at R=0.90;

[Depending on number of variables R can be adjusted in the range such as R=0.65-0.90, empirically determined, such as 0.65, 0.70, 0.75, 0.80, or 0.85, etc.]

Iteratively process the variables use Pearson correlation;

Output set of variables with less than 0.90 correlation.

As can be appreciated, the R variable may result in several columns (variables) being removed from a dataset because many publically available datasets have variables that are similar in some way. For example, for a particular zip code, the daytime population number and the employment statistics variable may be 90% correlated. In that case, the system selects on to use and discards the other. The selection of a variable to keep may be random or based on one or more factors. For example, a certain dataset may be given preference in a hierarchy or may cost less money to use. This R value may or may not be different than the R value of step 212.

In step 232, the remaining dataset is scaled by percentage using a known process. In a step 234, the two sets of data are connected, for example, combining the “A” dataset with the “B” dataset. The system attaches the Cluster IDs from the first stage clustering or “A” dataset to data scale by percentage.

In step 236, a standard centering algorithm is used. In this illustrative example though, the centering is done by the size variable (count of business).

Next in step 238, the dataset is processed through a principal components analysis. In this illustrative example, the standard prcomp routine in the R language is used, but with scaling and centering turned off by parameter. The default prcomp routine would apply a default scaling and centering if those features had not been intentionally turn off. In this way, the novel scaling and centering method described herein may be used without interference.

In yet another alternative, a substitute principal components analysis process may be used according to those taught in commonly-owned, co-pending U.S. Patent Application No. 61/747,462, filed by Cordery, et al., entitled Systems and Methods for Enhanced Principal Components Analysis, on Dec. 31, 2012, such application being incorporated by reference herein in its entirety. In yet other alternatives, prcomp scaling and/or centering may be substituted.

In step 240, the second stage clustering is performed on the dataset. In an illustrative embodiment, the K-means function of the R programming language may be used. Alternatively, the Two-Step clustering function in the commercially available SPSS package from IBM Corp. of Armonk, N.Y. may be utilized.

In step 242, the system gets profiling data related to the potential customers or SMBs (both Direct and Indirect). Here, the original variables are obtained, optionally scaled and centered.

In step 244, the system attaches cluster Identifiers from the second stage clustering, e.g., the scaled and centered data from steps 232 and 214.

In step 246 a visual representation of variable distributions is provided to the statistical operator of the system/analyst. A visual interpretation or automated best fit analysis may be performed. Here, a “cluster” is defined by which variables have the greatest influence and appear to have the most contribution to making that cluster a cluster. It is a defining characteristic of the cluster and the output of an unsupervised classification.

In step 248, the system provides templates for the analyst/statistical operator to create profile segments by the variables in a report that may be transmitted or printed and mailed to the client.

In certain embodiments described herein, the aggregation of data to the first stage clustering as described is a unique and at least sometimes important step in the method. This aggregation enables the systems and methods to be used to tailor the second stage clustering to a particular application (e.g., using customer data, unique geographies, or topic areas).

In additional certain embodiments of the application, the systems and methods provide not just end-stage profiles or end-stage clustering results (from second stage) to customers but also have the ability to provide B2B advertising clients/customers with “boutique” clusters—the results from intermediate steps (first stage results). In such embodiments, the system creates generic first stage clusters based on initial data (or non-private customer data) which allows the customer to later add customer's proprietary/private data at his end to perform second stage clustering to derive the second stage/final clustering results. Accordingly, the systems and methods provide access for such customization.

As can now be appreciated with reference to the teachings herein, a novel approach in one or more of the embodiments herein is to use data proxies created from aggregated data (aggregation using different levels of location) to perform customer segmentation. Here, an individual business data point may be replaced for the analysis with a data proxy such as a data point from an aggregate profile for a particular aggregation for a group such as one based upon location. (Building aggregate profiles based on individual business point data with a goal to come up with “robust data patterns” about a group to which each business belongs with a very high probability using its location). This improves on prior B2B segmentation systems that use available individual business point data as is. Such business point data may not be robust and accurate. Accordingly, the systems and methods herein may improve upon segmentation effectiveness by using this new proxy data.

The various systems and subsystems described herein may alternatively reside on a different configuration of hardware such as a single server or distributed server such as providing load balancing and redundancy. Alternatively, the described systems may be developed using general purpose software development tools including Java and/or C++ development suites. The server systems described herein typically include WINDOWS/INTEL Servers such as a DELL POWEREDGE Server running WINDOWS SERVER and include database software including MICROSOFT SQL and/or ORACLE 10i software. Alternatively, other servers such a SUN FIRE T2000 and associated web server software such as SOLARIS and JAVA ENTERPRISE and JAVA SYSTEM SUITES may be obtained from several vendors including Sun Microsystems, Inc. of Santa Clara, Calif. PC. Alternative database systems such as SQL may be utilized.

The user computing systems described may include WINDOWS/INTEL architecture systems running WINDOWS and INTERNET EXPLORER BROWSER such as the DELL DIMENSION E520 available from Dell Computer Corporation of Round Rock, Tex. While the electronic communications networks have been described as physically secure local area network (LAN) connections in a facility, external or wider area connections such as secure Internet connections may be used. Other communications channels such as Wide Area Networks, telephony and wireless communications channels may be used. One or more or all of the data connections may be protected by cryptographic systems and/or processes.

Each computer described herein may include one or more operating systems, appropriate commercially available software, one or more displays, wireless and/or wired communications adapter(s) such as network adapters, nonvolatile storage such as magnetic or solid state storage, optical disks, volatile storage such as RAM memory, one or more processors, serial or other data interfaces and user input devices such as keyboard, mouse and audio/visual interfaces. Laptops, tablets, PDAs and smart phones may alternatively be used herein.

Although the invention has been described with respect to particular illustrative embodiments thereof, it will be understood by those skilled in the art that the foregoing and various other changes, omissions and deviations in the form and detail thereof may be made without departing from the scope of this invention.

What is claimed is:

1. A computer implemented method for processing a multi-stage clustering of potential customers comprising:
obtaining data directly related to the potential customers;
processing the data directly related to the potential customers;
processing a first stage clustering of the processed data directly related to the potential customers;
obtaining data indirectly related to the potential customers;
processing the data indirectly related to the potential customers;
combining the processed, first-stage clustered data directly related to the potential customers and the processed data indirectly related to the potential customers; and
processing a second stage clustering of the combined data.

2. The method of claim 1, further comprising:
obtaining profiling data related to the potential customers;
attaching clustering identifiers from the second stage clustering to the profiling data; and
outputting a representation of important attributes by variable distributions.

3. The method of claim 1, wherein,
processing the data directly related to the potential customers includes:
removing a plurality of columns having at least a threshold number of values missing.

4. The method of claim 3, wherein,
processing the data directly related to the potential customers further includes:
removing a plurality of outlier rows using median absolute deviation.

5. The method of claim 4, wherein,
processing the data directly related to the potential customers further includes:
removing duplicate columns by correlation.

6. The method of claim 5, wherein,
processing the data directly related to the potential customers further includes:
scaling by percentage and centering by size.

7. The method of claim 6, wherein,
processing the data directly related to the potential customers further includes:
performing a principal components analysis with scaling and centering disabled.

8. The method of claim 7, wherein,
processing the data indirectly related to the potential customers includes:
removing a plurality of columns having at least a threshold number of values missing.

9. The method of claim 8, wherein,
processing the data indirectly related to the potential customers further includes:
removing a plurality of outlier rows using median absolute deviation.

10. The method of claim 9, wherein,
processing the data indirectly related to the potential customers further includes:
removing duplicate columns by correlation.

11. The method of claim 10, wherein,
processing the data directly related to the potential customers further includes:
scaling by percentage.

12. The method of claim 10, wherein,
before processing a second stage clustering of the combined data,
scaling the combined by percentage.

13. The method of claim 1, wherein:
the potential customers consist of businesses.

14. The method of claim 13, wherein:
the potential customers consist of small and medium businesses.

15. The method of claim 1, wherein:
the first stage clustering includes application of a two-step clustering process.

16. The method of claim 1, wherein:
the first stage clustering includes application of a K-means clustering process.

17. The method of claim 1, wherein:
the second stage clustering includes application of the K-means clustering algorithm.

18. The method of claim 1, wherein:
data directly related to the potential customers includes proxy data.
